(19) United States
(12) Patent Application Publication
(10) Pub. No.: US 2006/0225960 A1
(43) Pub. Date: Oct. 12, 2006

(54) Enclosed scaffolding assembly

(76) Inventors: Keith A. Ferlin, Summerland (CA); Clint Price, Kamloops (CA)

Correspondence Address: ANTONY C. EDWARDS, SUITE 200 - 270 HIGHWAY 33 WEST, KELOWNA, BC, V1X 1X7, CA

(21) Appl. No.: 11/396,465

(22) Filed: Apr. 4, 2006

Related U.S. Application Data
(60) Provisional application No. 60/670,264, filed on Apr. 12, 2005.

(51) Int. Cl. A62B 1/22

(52) U.S. Cl. 182/138

(57) ABSTRACT

A scaffolding assembly includes a plurality of sound attenuating sheets, detachably mounted on a frame erectable substantially adjacent to a structure. The frame includes sheet supporting members. The sheet supporting members and the plurality of sound attenuating sheets when mounted on the sheet supporting members define an enclosed working area adjacent the structure, so as to affect a seal to substantially contain air pollution and other detritus, and noise pollution within the enclosed scaffolding assembly when erected adjacent to the structure. An inclined catchment ramp is mounted along the length of at least one of the scaffold working decks so as to sandwich each ramp between the working deck and the adjacent wall of the structure.

### CROSS REFERENCE TO RELATED APPLICATION

This application claims priority from U.S. Provisional Patent Application No. 60/670,264 filed Apr. 12, 2005 entitled Enclosed Scaffolding Assembly.

### FIELD OF THE INVENTION

The present invention relates to the field of scaffolding structures and more particularly, it relates to an enclosed scaffolding structure providing an environment management system.

### BACKGROUND OF THE INVENTION

Boiler systems are used in many industries for the purpose of efficient heat transfer to serve a variety of different applications. Boiler systems typically include superheaters, reheaters, economizers, and boiler walls and floors. Boiler walls typically include rows of steel tubes mounted along, and essentially forming the interior walls of a boiler system. Each tube of the boiler walls is separated by a membrane which is usually made of steel as well. Variables such as proper maintenance of the boiler walls affect the overall efficiency of the boiler system. For example, wall thinning due to corrosion and erosion in boiler wall tubing is a significant operational concern. Corrosive agents, such as sulfur and chlorine, as well as the high pressure environment of the boiler system cause deterioration of the thickness of the boiler wall tubes, which will eventually cause ruptures. Exfoliation of scaling, which are formations of hard, brittle iron oxide on the surfaces of the water wall tubes, eventually cause erosion damage over time. By thermal coating the boiler wall tubes with a material that acts as a barrier between the corrosive and agents and erosive medium and the boiler wall tubes, the life of boiler walls may be substantially prolonged. In addition to improving the life of the boiler wall tubes, thermal coating also eliminates, or at least substantially reduces, the need for costly welding operations and changing of tubes.

Grit blasting or sand blasting is the process of cleaning and roughening the surface of the water wall tubes to provide a mechanical “tooth” to aid in the adhesion of the thermal coating onto the water wall tube surface. Aluminum oxide may be used as the abrasive agent. Because grit blasting operations contaminate the air, it would be preferable and advantageous to incorporate a system for cleaning the air and removing particulate from the airstream into the grit blasting operation. Furthermore, the noise generated by grit blasting operations can be deafening. As such, it would also be preferable and advantageous to incorporate a mechanism to contain the noise of the grit blasting operation so as to reduce the amount of noise pollution that may affect other workers maintaining other aspects of the boiler system. Typically only one wall of a boiler is grit-blasted at a time. Consequently, if the noise and air pollution associated with the grit blasting may be contained adjacent the wall being grit blasted, the other operations on the other walls of the boiler may be carried on simultaneously, thereby minimizing the down-time of the boiler. It is an object of the present invention to provide for such parallel path activity so that two incongruent work practices may be carried on in the same space simultaneously.

Boilers walls may be constructed in a wide variety of sizes and shapes. Most boilers are typically rectangular in plan and vary greatly in height. For example, high capacity industrial boiler systems are often well over 100 feet in height. To clean, inspect, and otherwise maintain the boiler walls, a scaffolding system may be installed to provide the workers with the means to access the entire boiler wall. Because of the economic consequences associated with outages, it is most advantageous if the scaffolding system may be erected and dismantled in an efficient manner. By enclosing the scaffolding structure to incorporate an air cleaning apparatus and a noise reduction system into the scaffolding structure, noise and sound pollution may be substantially eliminated so that workers may simultaneously carry out their respective duties without such safety concerns.

It is a further object of the present invention to reduce the danger to the structural viability of a scaffold by reason of accumulation on the scaffold of grit or other abrasives which may eventually cause the scaffold to collapse. For example, in applicant's experience a boiler measuring 35×72×100 feet inside the boiler ay use approximately 20 tons of grit during grit blasting of the inside of the boiler. Clearly an accumulation of all or part of that weight may jeopardize a scaffold structure. Thus it is an object of the present invention to provide for the removal of accumulations of grit, once used, from within the scaffold enclosure. Other structures such as bridges where cleaning for example by grit blasting removes undesirable build-up for example of paint, dirt, scale, waste, etc., may advantageously employ the present invention to inhibit pollution.

Enclosed scaffolding structures are known in the art. For example, applicant is aware of U.S. Pat. No. 5,038,889 to Jankowski which describes a scaffold enclosure having a plurality of panels secured to the scaffolding. Each panel has a closure and fasteners for securing an edge of the panel to the scaffolding. The panels are also engageable on one another to form a scaffold enclosure with sealed seams. Similarly, applicant is aware of U.S. Pat. No. 5,613,543 to Walton which describes a temporary protective covering system that provides temporary protection of outside objects from wind, rain, snow, or other elements. The protective covering system includes fabric or plastic panels that are erected to provide a continuous protective covering over an area, structure, or object.

Applicant is also aware of PCT application No. PCT/GB02/05711 filed by Bainbridge International Ltd. on Dec. 16, 2002, and entitled Containment System for Scaffolding Assembly wherein it is reported that it is usual to cover a scaffold structure to give shelter against the elements and also to prevent the escape of material such as dust or other detritus from within the enclosed area. The Bainbridge application also states that numerous systems for securing a covering to a scaffold structure have been proposed, and one system that is generally effective employs sheeting panels provided with leech edges formed along two opposed edges. Rails attached to the scaffolding structure are provided with channels to receive and retain the leech edges of the sheeting panels.

The Bainbridge application discloses a scaffolding assembly comprising a plurality of primary panels of sheet material and panel-holding members, the primary panels and the panel-holding members having complementary inter-engaging formations for securing each primary panel between neighbouring members to define an enclosed area, wherein a secondary panel is associated with one of the primary panels such that, in use, the secondary panel overlies one of the neighbouring members thereby to minimize leakage into or out from the enclosed area.

### SUMMARY OF THE INVENTION

In summary, the scaffolding assembly according to the present invention may be characterized in one aspect as including a plurality of sound attenuating sheets, detachably mounted on a frame erectable substantially adjacent to a structure. The frame includes sheet supporting members. The sheet supporting members and the plurality of sound attenuating sheets when mounted on the sheet supporting members define an enclosed working area adjacent the structure, so as to affect a seal to substantially contain air pollution and other detritus, and noise pollution within the enclosed scaffolding assembly when erected adjacent to the structure.

The enclosed working area is open on an open side immediately adjacent to an adjacent wall of the structure and otherwise closed to the ambient external environment including closed on an exterior side of the working area opposite the open side, and closed on the top, bottom and ends of the working area. The scaffolding assembly includes a vertically spaced apart array of elongate working decks, the working decks of the array parallel and horizontal within the enclosed working area. Each working deck of the array has an interior edge most closely adjacent both the adjacent wall of the structure and the open side of the enclosure, and an opposite exterior edge adjacent the sheets on the exterior side of the enclosure.

The scaffolding assembly further includes an inclined catchment ramp mounted along the length of, and adjacent to, the interior edge of at least one of the working decks so as to sandwich each ramp substantially snugly between its corresponding working deck and the adjacent wall of the structure. Each ramp is inclined upwardly from a corresponding interior edge towards the adjacent wall of the structure so as to catch detritus including debris and particulate matter falling from the adjacent wall of the structure and so as to urge the detritus downwards towards the interior edge of the working deck.

A disposal aperture is formed along the interior edge for disposal therethrough of the detritus as it is urged from the ramp. The aperture may be a vacuum inlet or head adapted for mounting in vacuum communication with a vacuum source for drawing the debris and particulate matter into the aperture, whereby the debris and particulate matter is removed from the scaffold enclosure. An elongate funnel may be formed in the work deck along the interior edge so that the aperture is recessed beneath the work deck at a lower end of the funnel.

In one embodiment the sheets include both sound dampening flexible curtains and sound dampening panels.

The working deck may be defined as having, in a horizontal plane, a length and a depth. The length of the deck is parallel to the adjacent wall of the structure and the depth of the deck is orthogonal to the adjacent wall of the structure. The inclined ramp has a length parallel to the length of the working deck and a depth substantially parallel to the depth of the working deck. In one embodiment, the depth of the ramp is substantially equal to the depth of the working deck and the length of the ramp is substantially equal to the length of the working deck.

Advantageously, the ramp is mounted to at least both a top-most and a bottom-most working deck in the array of working decks to thereby substantially seal a top and a bottom of the array against the adjacent wall of the structure. The sheets on the frame at the ends of the working area include end sheets and may include at least one door mounted on the frame to, respectively, substantially seal the ends of the working area and to provide access into the working area.

In an embodiment for use inside hollow structures such as boilers, the scaffolding assembly may be adapted so as to be erectable for snug substantially sealed mating engagement against an interior corner of the inside of the structure. In such an embodiment the working area and working decks may include an L-shape when viewed in plan view. Thus each ramp including those for the top-most and a bottom-most working deck extends the length of the L-shape so as to extend from each opposite end of the L-shape and around the interior corner of the structure so as to substantially seal thereagainst.

Advantageously at least one elongate, secondary sealing element may be mounted along an interior-most edge of each ramp, that is, the interior-most edge most closely adjacent the adjacent wall of the structure. The secondary sealing elements may extend the entire length of each ramp and may be detachably and selectively adjustably mounted on each ramp for adjustable snugging of the sealing element into substantially abutted engagement against the adjacent wall of the structure.

### BRIEF DESCRIPTION OF THE DRAWINGS

FIG. 1 is, in front perspective view, an L-shaped embodiment of the scaffold according to the present invention for mounting around, in abutting relation against, an interior corner of a hollow structure such as a boiler.

FIG. 1a is, in plan view, the scaffold of FIG. 1 illustrating the interior wall of the structure.

FIG. 2 is, in perspective view, a partially cut away enlarged view of a portion of FIG. 1.

FIG. 2a is, in perspective view, a floor mounted vacuum head for mounting in the floor of the working decks as seen in FIG. 2.

FIG. 3 is, in front perspective view, a rosette cover for use in the scaffold according to the present invention.

FIG. 4 is, in rear elevation view, the rosette cover of FIG. 3 mounted to a vertical scaffold member.

FIG. 4a is, in rear elevation view, the rosette cover of FIG. 4 dismounted from the vertical scaffold member.

FIG. 4b is, in perspective view, a mounting clamp from the rosette cover of FIG. 4a for releasably mounting the rosette to a vertical scaffold member.

FIG. 5 is, in perspective view, a left hand vertical corner cover, the right hand corner cover being a mirror image.

FIG. 6 is, in perspective view, a right hand vertical closure panel support, the left hand closure panel support being a mirror image.

FIG. 7 is, in perspective view, a mounting bar.

FIG. 8 is, in rear perspective view, the scaffold of FIG. 1.

FIG. 8a, in rear perspective view, a partially cut away enlarged segment of the scaffold of FIG. 8.

FIG. 9 is, in front perspective view, a partially cut away enlarged segment of the scaffold of FIG. 1.

FIG. 10 is, in rear perspective view, the scaffold segment of FIG. 9.

FIG. 11 is, in perspective view, a sound attenuating panel for mounting into the scaffold according to the present invention.

FIG. 12 is, in perspective view, a partially cut away enlarged end view of the scaffold according to the present invention.

FIG. 13a is, in perspective partially exploded view, a pair of sound reducing curtains, the upper curtain mounting into a channel formed on a horizontal t-bar and the lower curtain hung from the channel by a hook-shaped rail.

FIG. 13b is, in side elevation assembled view, the mounting of the pair of curtains to the t-bar of FIG. 13a.

FIG. 13c is, in rear perspective view, the upper curtain mounted into the t-bar of FIG. 13a.

FIG. 13d depicts in side elevation view, the mounting of a top vinyl curtain to a working deck.

FIG. 13e depicts in side elevation view, the mounting of a bottom vinyl curtain to a working deck.

FIG. 14 is, in perspective view, a closure panel angle member.

FIG. 15 is, in plan view, a rosette cover, closure panel support, closure panel and closure panel angle member assembled so as to seal between the rosette cover and an interior wall of a boiler.

FIG. 16 is, in perspective view, a working deck, partially cut away, according to the present invention.

FIG. 17 is, in partially cut away perspective view, an entryway into a working deck of the scaffold according to the present invention.

### DETAILED DESCRIPTION OF EMBODIMENTS OF THE INVENTION

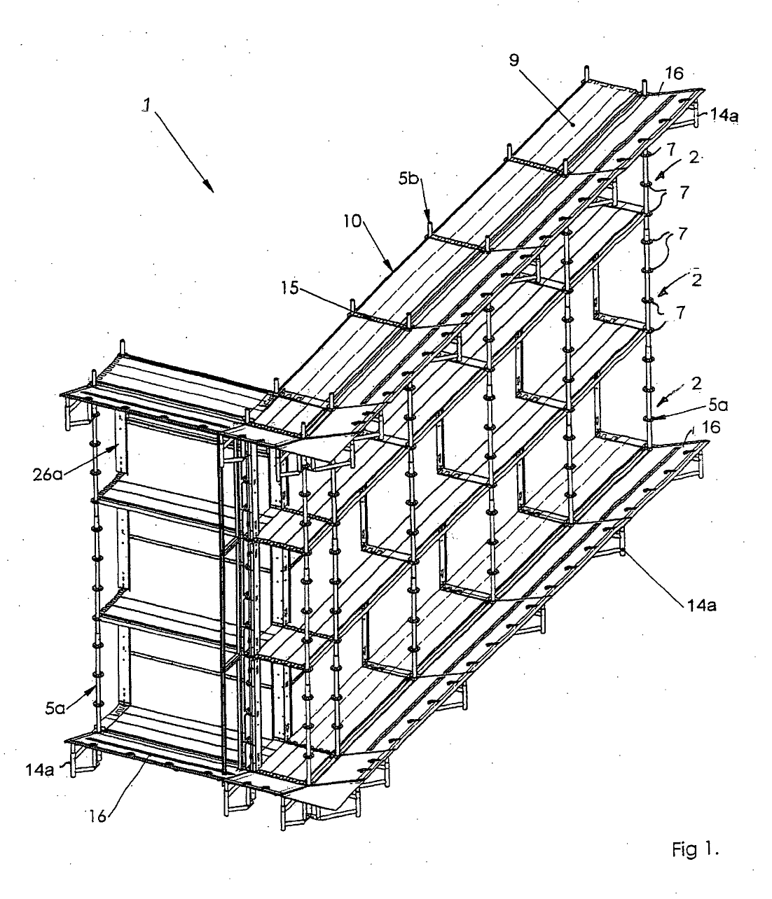

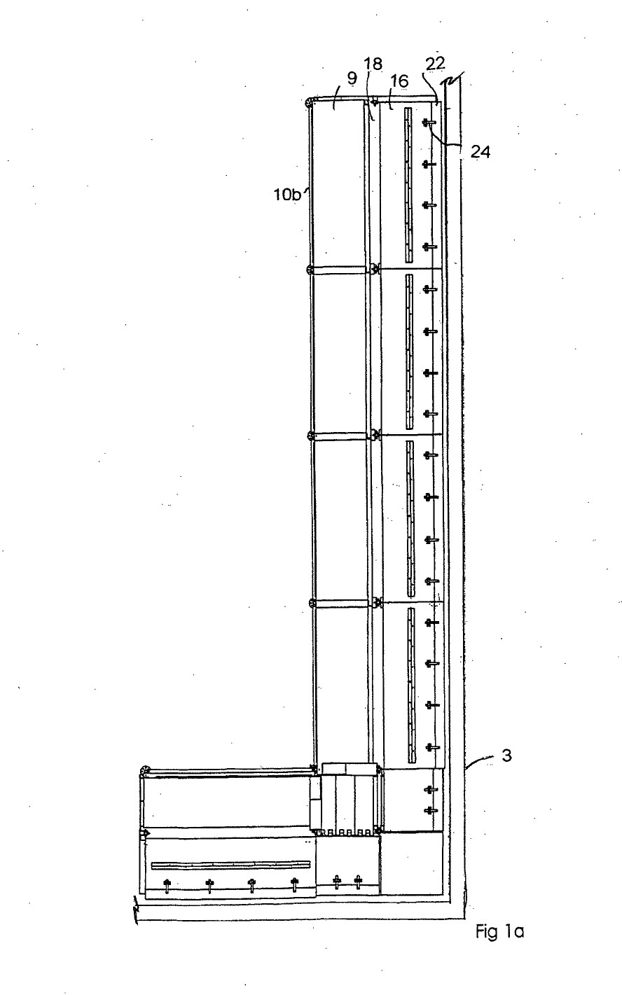

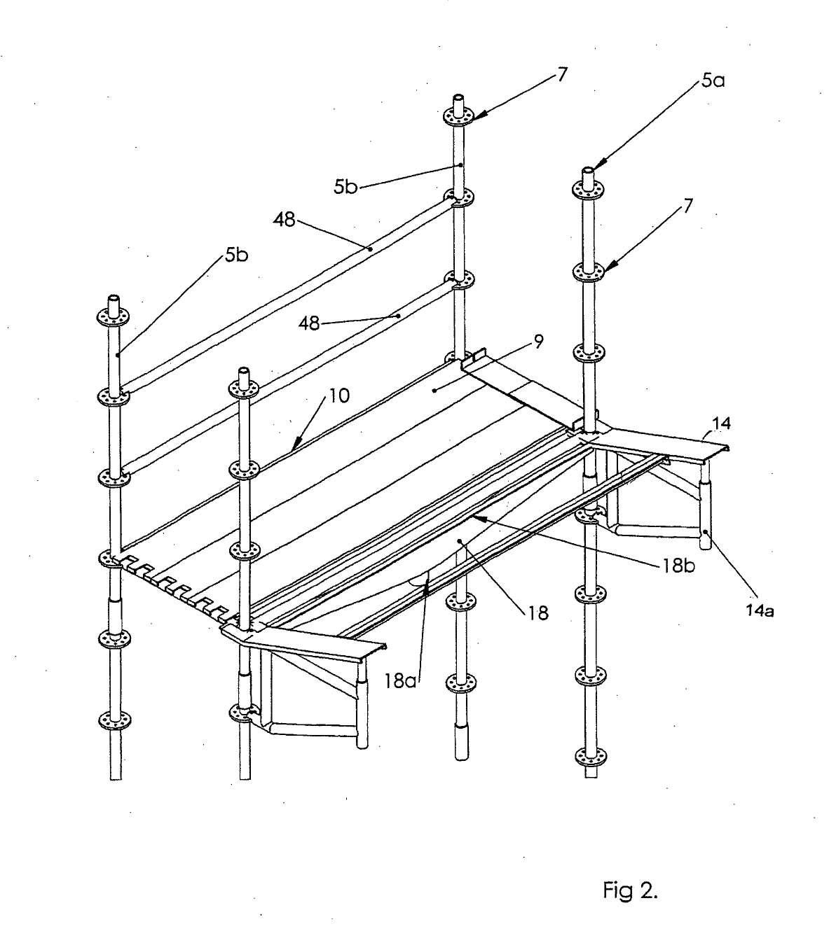

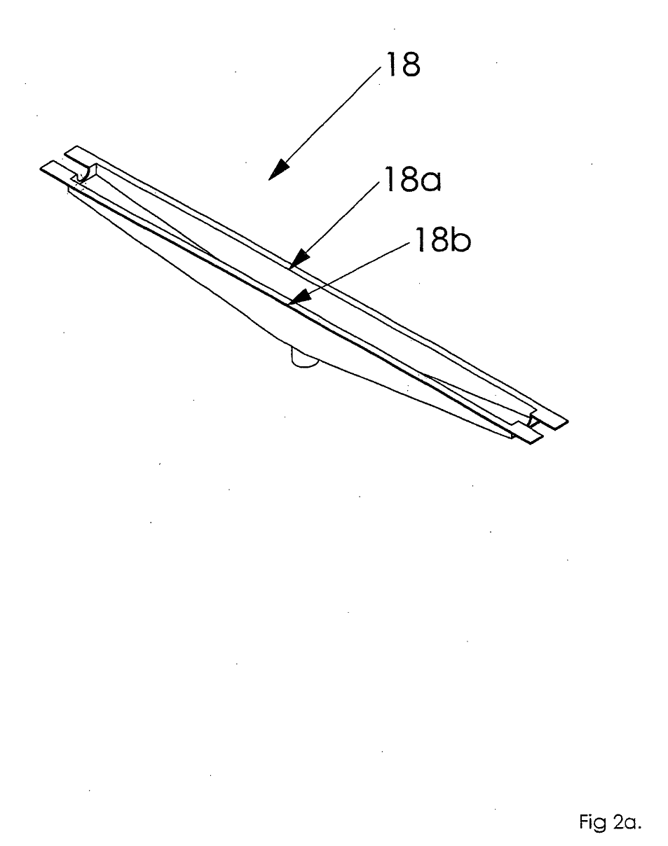

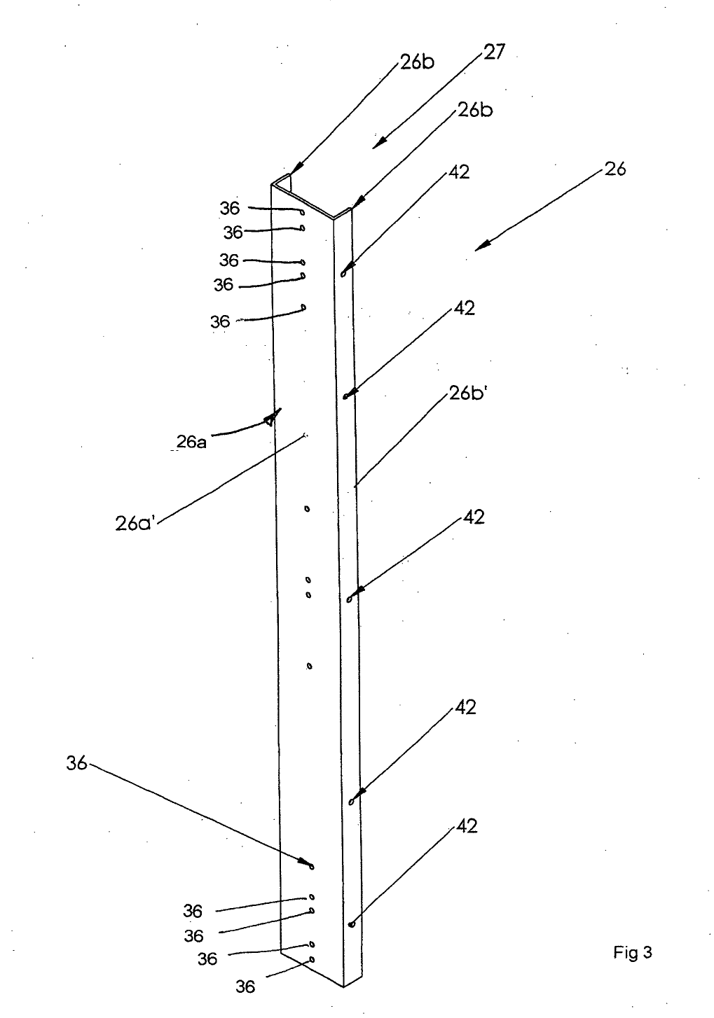

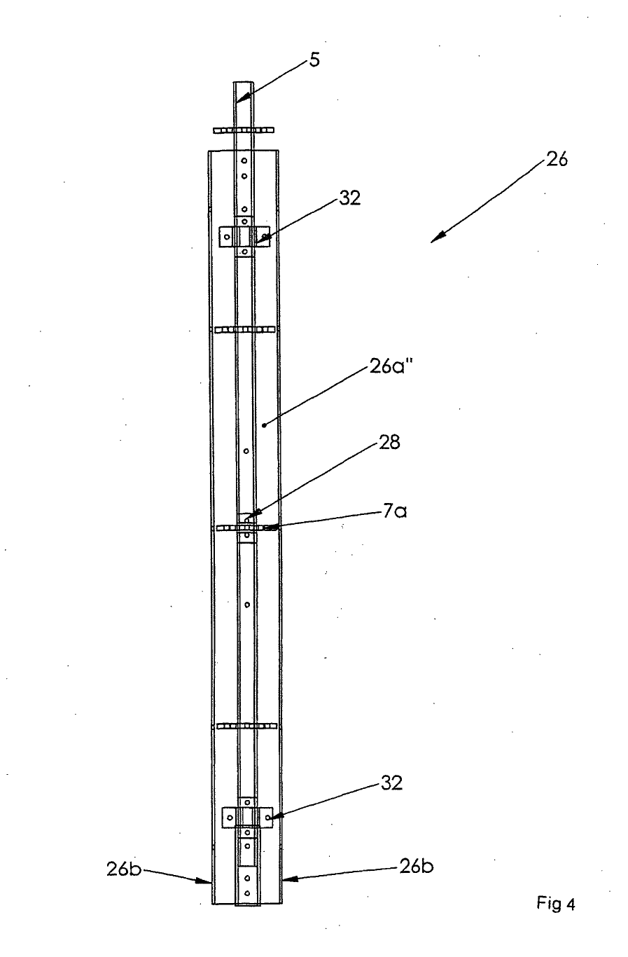

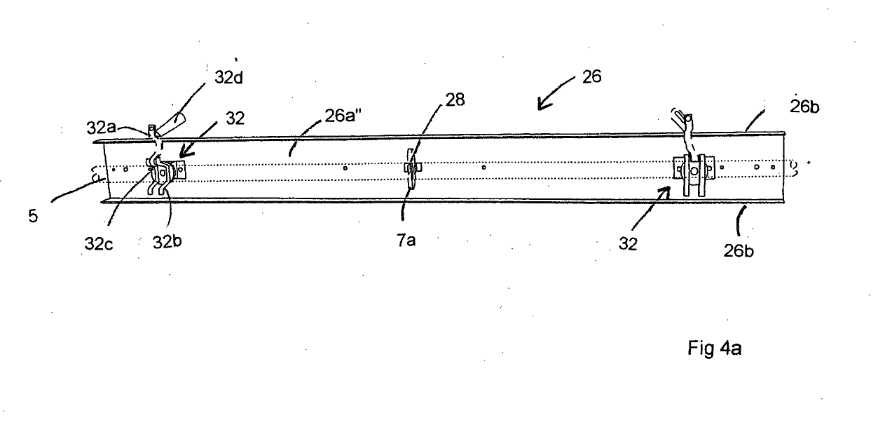

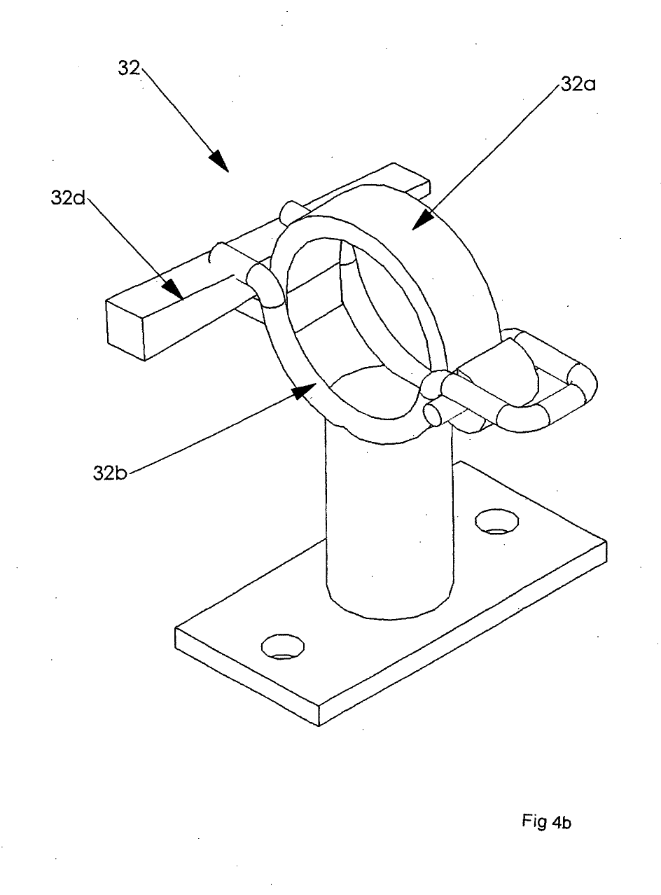

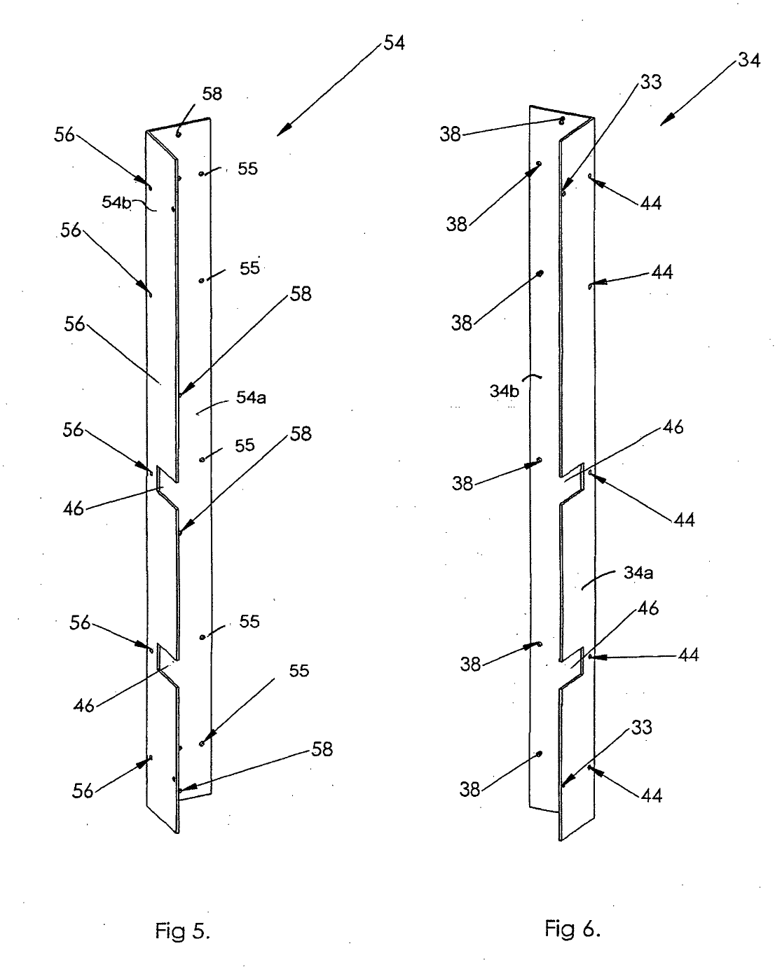

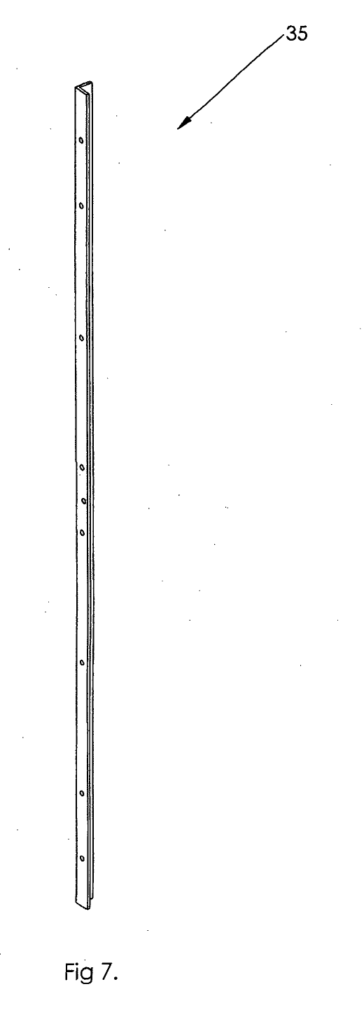

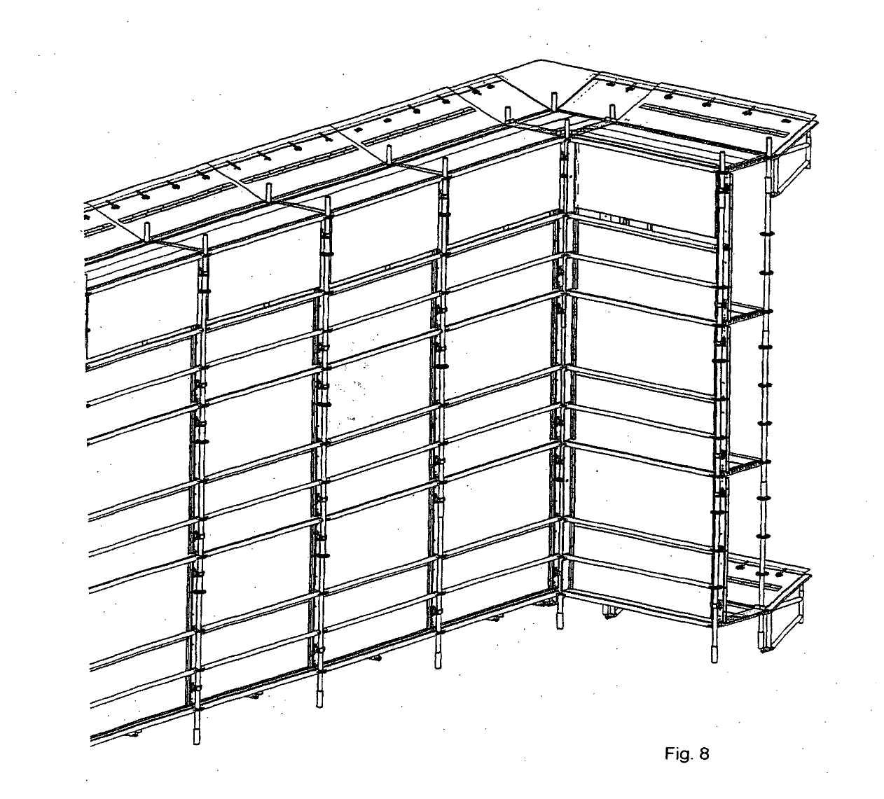

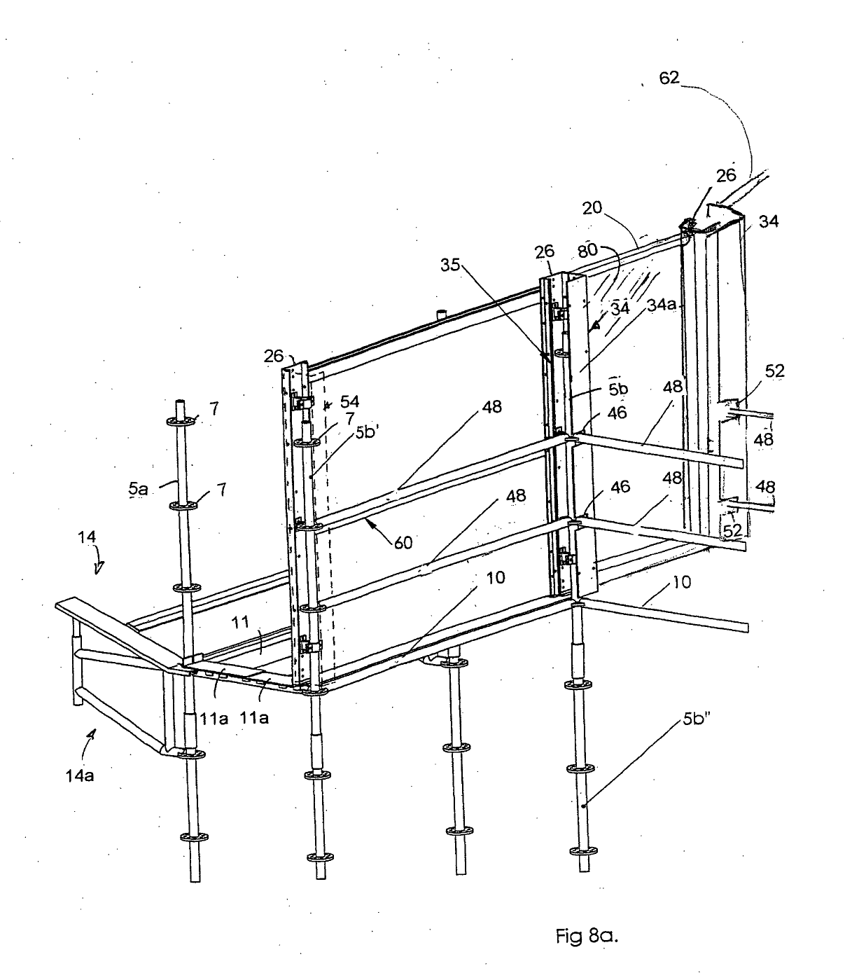

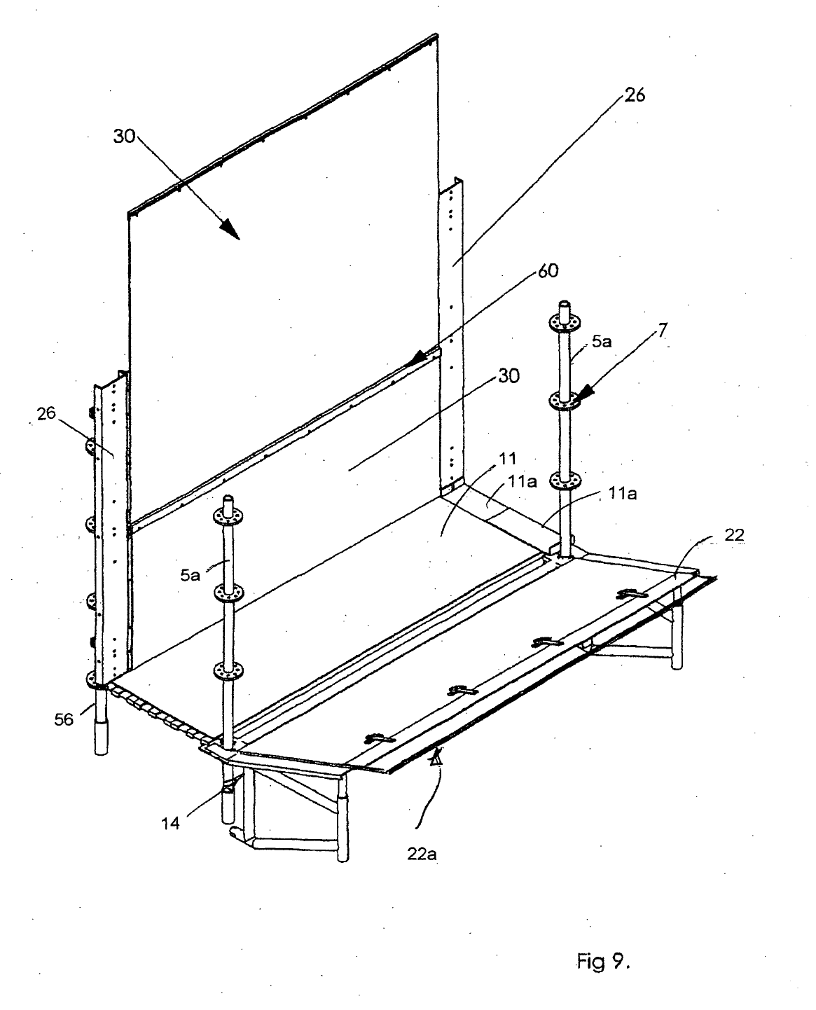

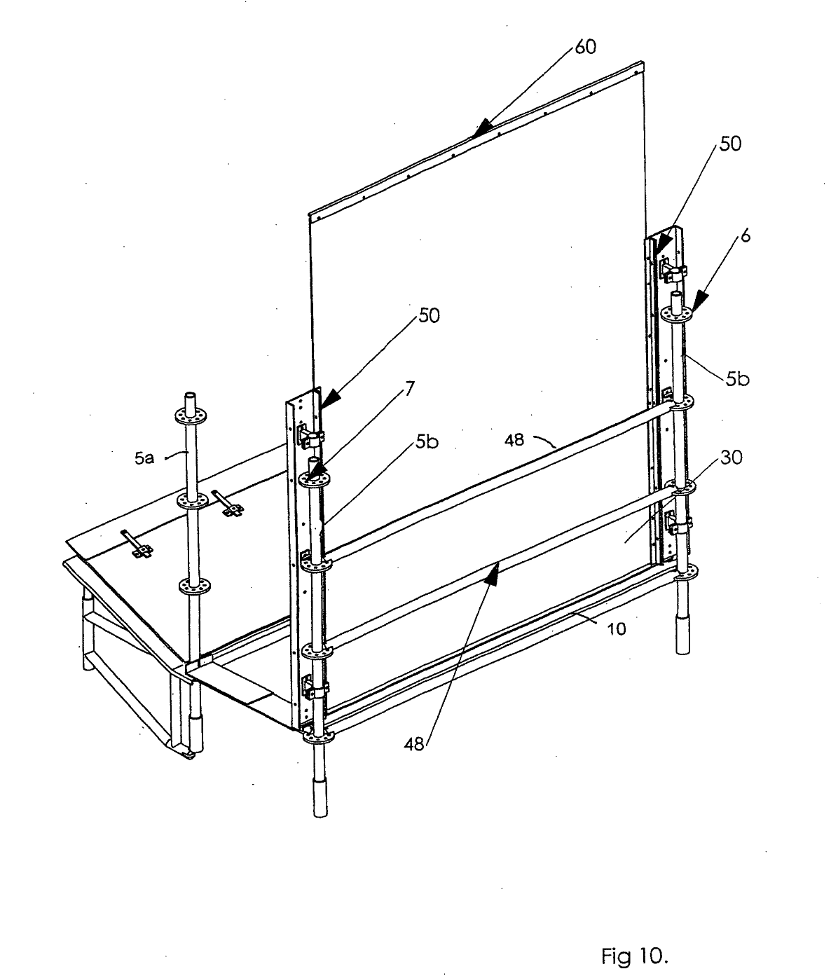

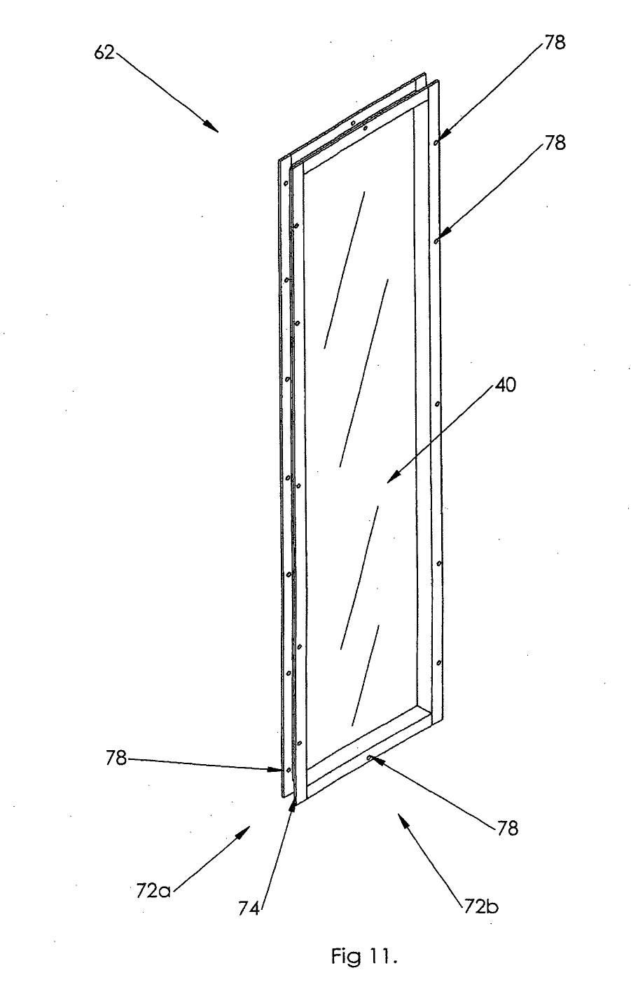

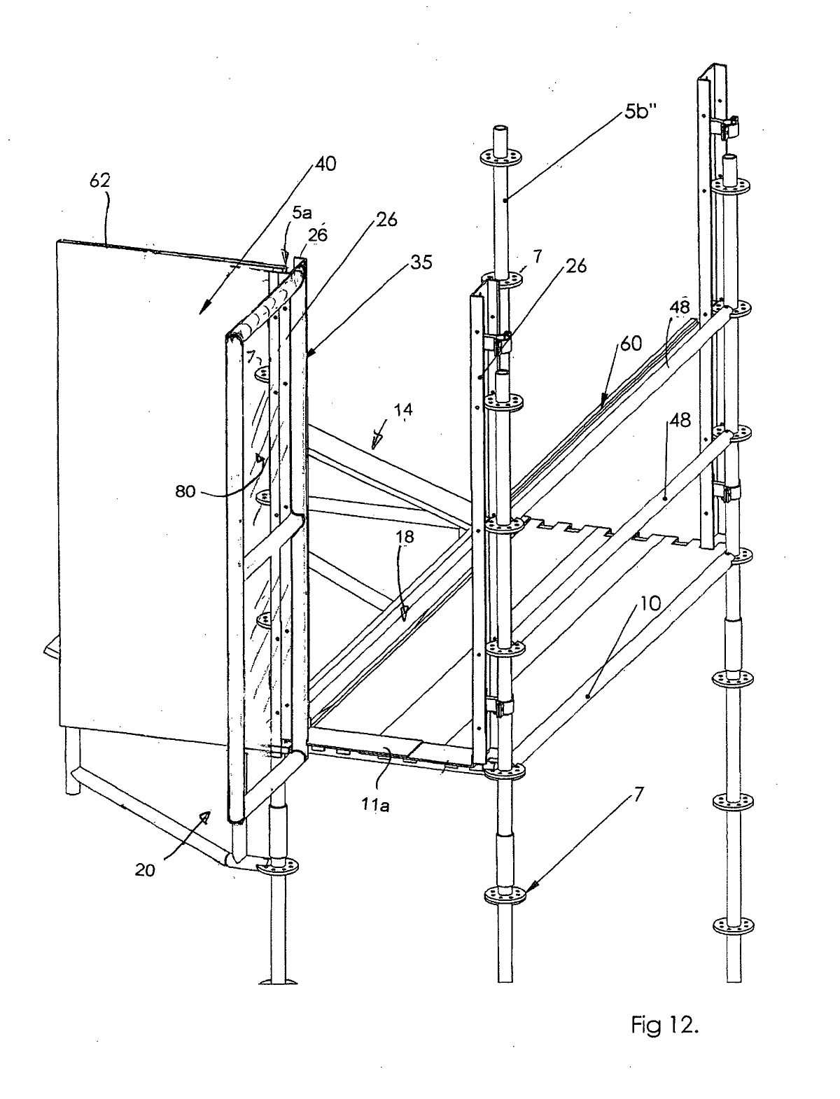

With reference to FIGS. 1 to 12, the enclosed scaffolding assembly 1 includes a plurality of vertical supports 5 and a plurality of horizontal supports 10 known in the industry as standards and ledgers, respectively, and a plurality of crossbar supports 15. Standards 5, ledgers 10 and crossbar supports 15 are detachably mountable to form a typical scaffolding structure having a plurality of work decks 2 and elevation levels. At least one door 20 is provided at a first end of each elevation level so as to give access to each work deck 2 at each elevation level. A plurality of sound reducing curtains 30 are detachably mounted to the scaffolding structure such that the curtains 30 at least partially enclose the scaffolding structure around the inside perimeter, a structure such as a boiler wall 3 having tubes 3a. A plurality of sound reducing panels 40 are mounted between boiler wall 3 and standards 5. In an embodiment of the invention, the plurality of sound reducing curtains 30 and the plurality of sound reducing panels 40 mounted to the scaffolding structure substantially encloses the scaffolding structure along the boiler wall. In an embodiment of the invention, the enclosed scaffolding assembly 1 according to the present invention is configured to support a device for removing airborne particulate matter such as described by way of example in U.S. Pat. No. 6,478,859.

Without intending to be limiting, the vertical supports or standards 5, the horizontal supports or ledgers 10 are typically pipes made from steel. The standards 5 generally measure two meters or six feet six inches in length and two inches in diameter, although different dimensions of the vertical supports 5 are within the scope of the present invention. The ledgers 10 are 2″ in diameter and are of different dimensions. The vertical supports 5 of the scaffolding structure closest to the boiler wall are hereinafter known as the interior standards 5a and the vertical supports furthest away from the boiler wall are hereinafter known as the exterior standards 5b. Similarly, the horizontal supports 10 of the scaffolding structure closest to the wall are hereinafter known as the interior ledgers and the horizontal supports furthest away from the wall are hereinafter known as the exterior ledgers. Generally, any reference to the orientation of a part closest to the boiler wall is hereinafter known as the interior and any reference to the orientation of a part furthest away from the boiler wall is hereinafter known as the exterior.

Each standard 5 includes a plurality of rosettes 7 mounted spaced apart along the standard. Although not intended to be limiting, typically four rosettes 7 are mounted on each standard 5, that is a standard 2 meters or 6′ 6″ long, in substantially equally spaced apart orientation. Typically, the ledgers 10 are detachably mounted to the rosettes 7 of the standards 5 to form a typical scaffolding structure having a plurality of work decks 2 and elevation levels. A work platform 9 extends between each pair of ledgers 10 that connect the interior and exterior standards on each work elevation level of the enclosed scaffolding assembly to support the workers that may be grit blasting or otherwise maintaining the boiler wall. Preferably, a work deck seal plate 11 is mounted on top of each work platform 9 to provide greater stability to the work platform 9 and to seal any gaps on the work decks. For example, because the work platform 9 is usually perforated metal planks, the work deck seal plate 11 will seal any gaps in the work decks at the floor and ceiling work elevation.

In an embodiment of the present invention, there is a minimum two foot clearance between the boiler wall and the interior standards 5a of the scaffolding structure such that there is sufficient distance between the boiler wall and the workers on each work deck 2. At the floor and ceiling work elevation, detachably mounted to each interior standard 5a at a position adjacent to and substantially at the same level as the work platform 9, is a sloped support 14. Preferably, the sloped support 14 is mounted to a two plank wide side bracket 14a attached to at least one rosette 7 of each interior standard 5a. The sloped support 14 supports a catchment ramp such as a sloped seal plate 16. In an embodiment of the invention, the sloped seal plate 16 engages and rests on top of the sloped support 14 such that the sloped seal plate 16 extends between the interior standard 5a and the boiler wall so as to be inclined at an angle from the interior standards to the boiler wall. Formed along and extending a first longitudinal side of the sloped seal plate 16 is a L-shaped flange 16a. The L-shaped flange 16a engages and secures onto a first longitudinal edge 18a of a hopper 18 which is detachably mounted substantially adjacent to and along a longitudinal interior side 9a of each work platform 9. The hopper 18 or collecting element is configured to collect from and drain debris away from seal plate 16 which drops into the seal plate as a result of grit blasting. In an embodiment of the invention, the hopper 18 is supported at its ends by the sloped support 14 and secured into position by mounting of the work deck seal plate 11 on top of the work platform 9. The work deck seal plate 11 includes two L-shaped flanges attached to the vinyl sound barrier with one of the L-shaped flanges 11a extending a longitudinal interior side of the work deck seal plate 11 such that the L-shaped flange 11a engages and secures onto a second longitudinal edge 18b of the hopper 18. The second L-shaped flange 11b extends along a longitudinal exterior side of the work deck seal plate 11 to secure the bottom edge of sound reducing curtain 30 so as to effect a seal.

Detachably and adjustably mounted to a second longitudinal side 16b of the slope seal plate 16 opposing the first longitudinal side 16a is a seal bar 22. Seal bar 22 is constructed in two parts so that it may clamp a seal strip 22a constructed of plywood which may snugly mate with the boiler wall. In an embodiment of the invention, seal strip 22a may be secured by a conventional securing means 24 such as a screw or bolt. Preferably, seal bar 22 is adjustable generally perpendicularly to the boiler wall such that seal bar 22 may be advanced towards or retracted back from the boiler wall such that the seal strip 22a may engage and mate with the boiler wall. After seal strip 22a is snugly mated to boiler wall 3, sealing foam is applied to seal between seal strip 22a and boiler wall 3.

Detachably mounted on each of the exterior standards is a rosette cover 26. The rosette cover is generally “U”-shaped in cross section and typically extends the longitudinal length of the exterior standard 5b between the work decks 9 of each elevation. The rosette cover 26 includes a surface member 26a disposed between a first and a second opposing flange 26b wherein the surface member 26a forms the base of the “U” shape and the first and second opposing flanges 26b form the legs of the “U” shape. The surface member 26a and the first and second opposing flanges 26b of the rosette cover 26 therefore define a channel 27. Preferably, the rosette cover 26 is detachably mounted on each of the exterior standards 5b such that an outer surface 26a′ of the surface member 26a of each rosette cover 26 is facing towards and parallel to the boiler wall to be enclosed by the scaffolding structure. The portion or segment of the boiler wall to be enclosed is also known as the active wall. In an embodiment of the invention, disposed within the channel 27 and mounted to an inner surface 26a″ of the surface member 26a of each rosette 26 cover are centering tabs 28. Centering tabs 28 are configured to engage at least one of the plurality of rosettes 7 mounted on the exterior standard 5b to assist in properly aligning the rosette cover 26 such that the rosette cover 26 is perpendicular to the work deck above and below and a plane containing adjacent surface members 26a is orthogonal to a plane containing work deck 2. If the rosette cover surface members 26a are not parallel to each other, and preferably co-planar, and square to the work decks, the vertical panel angle 50 and the panel t-bar 60, described below, will not properly align for the sound reducing curtains 30 to be mounted. Preferably, the centering tabs 28 are two angle-iron pieces configured to engage the centre rosette 7a of the interior standard 5b by mating engagement. Also disposed within the channel 27 and mounted to the inner surface 26a″ of the surface member 26a of the rosette cover 26 are securing means, such as clamps 32 or couplers for securing the rosette cover 26 onto the interior standard 5b. Clamps 32 may be Van Thiel™ couplers which each include first and second generally semi-circular members 32a, 32b, wherein the first semi-circular member 32a is pivotably mounted at a first end 32c by way of a pivot pin to a first end of the second semi-circular member 32b. The Van Thiel™ coupler 32, as would be known to one skilled in the art, is configured to receive the exterior standard 5b. When the exterior standard 5b is received in the second semi-circular member 32b, the first semi-circular member 32a may be pivoted about the pivot pin such that the first semi-circular member 32a may be wrapped around the exterior standard 5b to generally form a ring around the exterior standard 5b. A second end of the first semi-circular member 32a engages a second end of the second semi-circular member 32b which may be secured together by fastening means 32d such as a latching mechanism to secure the rosette cover 26 to the exterior standard 5b. Preferably, two Van Thiel™ couplers are mounted to the inner surface 26a″ of the surface member 26a of the rosette cover 26, one at each end of the rosette cover 26. The rosette cover 26 is thereby mounted on the exterior standard 5b by securing centering tabs 28 onto centre rosette 7a and securing Van Thiel™ couplers 32 around the exterior standard 5b.

In an embodiment of the invention where the enclosed scaffolding assembly 1 is erectable substantially adjacent to only a portion or segment of the boiler wall such that the enclosed scaffolding assembly 1 does not extend from a first corner of the boiler wall to an opposing second corner of the boiler wall, a rosette cover 26 is also detachably mounted on the extreme interior standard 5a of at least a first end of the enclosed scaffolding assembly 1 in the same manner described above. Preferably, a rosette cover 26 is detachably mounted on the end-most interior standard 5a of both opposite ends of the enclosed scaffolding assembly. Rosette covers 26 are mounted on the end-most interior standards 5a such that the surface members 26a are parallel to the corresponding surface members 26a of the rosette covers 26 mounted on the end-most exterior standards 5b″. A closure panel support 34 may then be mounted on each of the rosette covers 26 mounted on each end-most interior standard 5a. The closure panel support 34 is generally “L”-shaped in cross section and typically extends the longitudinal length of the rosette cover 26. Closure panel supports 34 include a first surface member 34a with apertures 33 which correspond with the apertures of the surface member 26b of the rosette cover 26, and cutouts 46 which correspond to the placement of hand rails 48. Preferably, the surface member 26b of the rosette cover 26 and the first surface member 34a of the closure panel support 34 includes a plurality of corresponding apertures 33 such that the closure panel support 34 may be mounted to the rosette cover 26 by way of conventional securing means such as bolts that journal through the corresponding plurality of apertures 33 on the surface member 26b of the rosette cover 26 and the first surface member 34a of the closure panel support 34. More specifically, an inner surface of the first surface member 34a of the closure panel support 34 mates with the outer surface 26b′ of the surface member 26b of the rosette cover 26. The closure panel support 34 also includes a second surface member 34b perpendicular to the first surface member 34a of the closure panel support 34. The second surface member 34b of the closure panel support 34 may have the same dimensions as the first surface member 34a of the closure panel support 34. The second surface member 34b of the corner cover 34 engages one of the two exterior surfaces 26b′ of one of the opposite flanges 26b of the rosette cover 26.

In an embodiment of the invention, flanges 26b of the rosette cover 26 and the second surface member 34b of the corner cover 34 include a plurality of corresponding apertures 42 and 44 respectively such that the second surface member 34b of the corner cover 34 may be mounted to one of the flanges 26b of the rosette cover 26 by way of conventional securing means such as bolts that journal through the corresponding apertures 42 and 44. Preferably, the first surface member 34a of the corner cover 34 includes at least one recess 46 for receiving a handrail 48 on the exterior side of the work platform 9. Typically, a first end of the handrail 48 is mounted to the rosette 7 of a first standard and a second end of the handrail 48 is mounted to the rosette 7 a second standard adjacent to the first standard. Preferably, a seal pad 52 is mounted between the recess 46 and the handrail 48 so as to assist in creating a seal. Mounting the rosette cover 26 on the end-most exterior standard 5b on opposite ends of a work deck 2 provides for a door frame such that door 20 may be hung at an end or at opposite ends of a work deck 2.

In an alternative embodiment of the invention where the enclosed scaffolding assembly 1 is erectable substantially adjacent to the active wall so as to enclose the entire active wall, for example, the enclosed scaffolding assembly 1 extends from one interior corner of the boiler wall to a second opposite interior corner of the boiler wall, a rosette cover 26 is detachably mounted on a standard 5b″ of at least a first end of the enclosed scaffolding assembly 1 such that the rosette cover 26 is ninety degrees to the rosette cover 26 mounted on the immediately adjacent interior standard 5b′. Preferably, a rosette cover 26 is detachably mounted on each end-most standard 5b″ of both opposite ends of the enclosed scaffolding assembly 1. For greater clarification, the surface member 26a of the rosette cover 26 mounted on the end-most standard 5b″ is perpendicular relative to the boiler wall and the surface member 26a of the rosette cover 26 mounted on the end-most standard 5b″ is facing towards and parallel to one of the opposing flange 26b of the immediately adjacent rosette cover 26. A corner cover 54 may then be mounted on each of the rosette covers 26 mounted on the standard 5b′ immediately adjacent to the standard 5b″. The corner cover 54 is mounted to the interior standard 5b′ immediately adjacent to the standard 5b″ such that a first surface member 54a of the corner cover 54 faces and is parallel to the surface member 26a of the rosette cover 26 mounted on the standard 5b″.

Similar to the corner cover 34, the corner cover 54 is also generally “L”-shaped and typically extends the longitudinal length of the rosette cover 26. The corner cover 54 includes a first surface member 54a which corresponds with the dimensions of the surface member 26a of the rosette cover 26 and a second surface member 54b formed such that the second surface member 54b is oriented perpendicular to the first surface member 54a of the corner cover 54. The second surface member 54b has the same dimensions as the first surface member 54a of the corner cover 54. Preferably, the second surface member 54b of the corner cover with nuts 54 includes at least one recess 46 for receiving handrail 48. Seal pads 52 may be mounted between the recess 46 and the handrail 48 so as to assist in creating a seal. The second surface member 54b also includes a plurality of apertures 56 that correspond to the apertures 42 and 36 on the opposing flange members 26b and the surface member 26a of the rosette cover 26. The first surface member 54a of the corner cover 54 also includes a plurality of apertures 58 that correspond with the plurality of apertures 42 on the opposing flange 26b of the rosette cover 26 such that the corner cover 54 may be mounted to one of the two flanges 26b of the rosette cover 26 by way of conventional securing means such as bolts that journal through the corresponding plurality of apertures 42 on one of the flanges of the rosette cover and the plurality of apertures 58 on the first surface member 54a of the corner cover 54. The difference between the corner cover 34 and the corner cover 54 is that the corner cover 54 also includes a plurality of apertures 55 along a second longitudinal edge of the first surface member 54a of the corner cover with nuts 54 that correspond with the plurality of apertures 42 and 36 on the opposing flanges and surface member 26a of the rosette cover 26. A door stop angle (not shown) may be detachably mounted to the plurality of apertures 55 along the second longitudinal edge of the first surface member 54a of the corner cover 54.

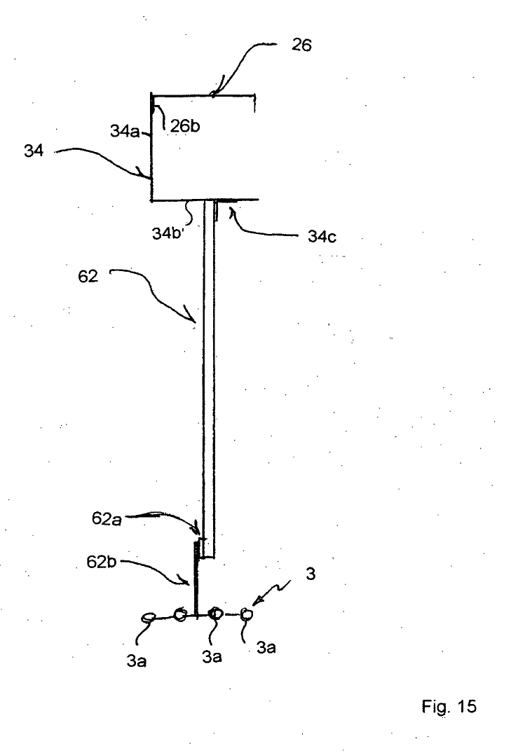

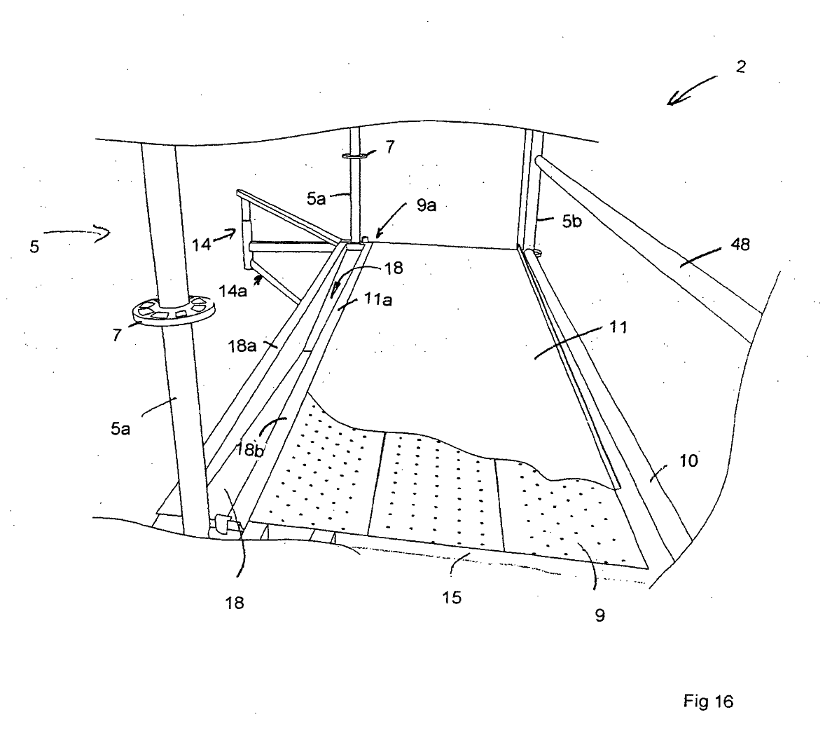

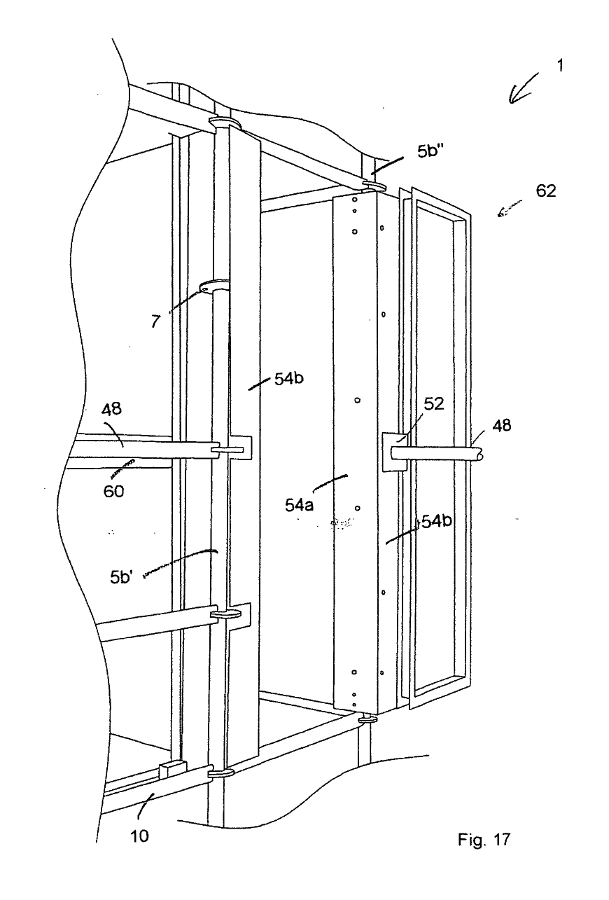

In a full enclosure embodiment, a corner cover 54 is detachably mounted to the rosette cover 26 mounted on the end-most standard 5b. The surface member 26a of the rosette cover 26 and the first surface member 34a of the closure panel support 34 includes a plurality of corresponding apertures 36, 38 such that the closure panel support 34 may be mounted to the rosette cover 26 by way of conventional securing means such as bolts that journal through the corresponding plurality of apertures 36, 38 on the surface member 26a of the rosette cover 26 and the first surface member 34a of the closure panel support 34. The second surface member 34b formed along the first longitudinal edge of the first surface member 34a engages an exterior surface 26b′ of the opposing flange 26b of the rosette cover 26 furthest away from the boiler wall. In an embodiment of the invention, the second surface member 34b of the closure panel support 34 includes a plurality of apertures 44 corresponding with the plurality of apertures 42 and 36 on the opposing flange 26b and the surface member 26a of the rosette cover 26, respectively. A closure panel 62 may be mounted to the second surface member 34b by way of angle 34c which is secured by conventional securing means such as bolts that journal through the plurality of apertures 44 on the second surface member 34b and the corresponding apertures on the closure panel 62. Preferably, the second surface member 34b of the closure panel support 34 includes at least one recess 46 for receiving handrail 48. Preferably, a seal pad 52 may be mounted between the recess 46 and the handrail 48 so as to assist in creating a seal. FIG. 15 is a plan view of rosette cover 26, closure panel support 34, closure panel 62, and closure panel angle 34c. Plywood strip 62b is attached to the closure panel 62 by a first plywood strip 62a so that a second piece of plywood 62b that makes the seal to the boiler wall 3.

In the embodiment wherein the enclosed scaffolding assembly encloses only a portion or segment of the boiler wall, a threshold plate 11a may be detachably mounted between the rosette covers 26 mounted on the end-most standard 5a and the end-most standard 5b″ of both opposite ends of the enclosed scaffolding assembly so as to create a seal between the work decks 2 of each level. A first threshold plate may be detachably mounted so as to extend between an upper portion of the rosette cover 26 mounted on standard 5a and the rosette cover 26 mounted on standard 5b″. A second threshold plate may be detachably mounted so as to extend between a lower portion of the rosette cover 26 mounted on standard 5a and the lower portion of the rosette cover 26 mounted on standard 5b″. The threshold plate thereby joins the opposing rosette covers on each end of a work deck. The threshold plate includes a plate that extends between the rosette covers 26. At a first and second opposite end of the plate are a first and a second flange, respectively, wherein the first and the second opposing flange are perpendicular to the plate. The first and the second opposing flange each include at least one aperture that corresponds to the upper and lower apertures 36 on the surface member 26a of the rosette cover 26, which also correspond with the upper and lower apertures 58 on the first surface member 54a of the corner cover 54. The first flange of a first threshold plate may then be detachably mounted to an upper portion of the first surface member 54a of the corner cover 54 and an upper portion of the surface member 26a of the rosette cover 26 mounted on standard 5a by way of conventional securing means such as bolts that journal through the corresponding apertures 38 and 36 on the first surface member 54a of the corner cover 54, the surface member 26a of the rosette cover 26, and the first flange. The second opposing flange of the first threshold plate may also be detachably mounted to an upper portion of the surface member 26a of the rosette cover 26 mounted on standard 5b″ by way of conventional securing means such as bolts that journal through the corresponding apertures 36 on the upper surface member 26a of the rosette cover 26 and the second flange. A second threshold plate may be similarly mounted to the lower portion of the first surface member 54a of the corner cover 54 mounted on standard 5a, the surface member 26a of the rosette cover 26 mounted on standard 5a and the surface member 26a of the rosette cover 26 mounted on standard 5b″.

Alternatively, in the embodiment wherein the enclosed scaffolding assembly 1 encloses the entire wall, the threshold plate may also be detachably mounted between the rosette cover 26 mounted on standard 5b″ and the rosette cover 26 mounted on the immediately adjacent interior standard 5b′ of both ends of the enclosed scaffolding assembly 1 so as to effect a seal between the work decks 2 of each level. A first threshold plate may be mounted so as to extend between an upper portion of the rosette cover 26 mounted on standard 5b″ and the rosette cover 26 mounted on the immediately adjacent standard 5b′ and a second threshold plate may be detachably mounted so as to extend between a lower portion of the rosette cover 26 mounted on the standard 5b″ and the rosette cover 26 mounted on the immediately adjacent standard 5b′. In an embodiment of the invention, the first flange of a first threshold plate may then be detachably mounted to an upper portion of the first surface member 54a of the corner cover 54 and an upper portion of one of the opposing flanges 26b of the rosette cover 26 mounted on the immediately adjacent standard 5b′ by way of conventional securing means such as bolts that journal through the corresponding apertures 58 and 42 on the first surface member 54a of the corner cover 54, the opposing flange 26b of the rosette cover, and the first flange of the threshold plate. The second opposing flange of the first threshold plate may also be detachably mounted to an upper portion of the first surface member 54a of the corner cover 54 and the surface member 26a of the rosette cover 26 mounted on standard 5b″ by way of conventional securing means such as bolts that journal through the corresponding apertures 38 and 36 on the upper portion of the first surface member 34a of the corner cover 54 and the surface member 26a of the rosette cover 26 and the second flange of the threshold plate. A second threshold plate may be similarly mounted to the lower portion of the first surface member 54a of the corner cover 54 and one of the opposing flanges 26b of the rosette cover 26 mounted on the immediately adjacent standard 5b′ and the lower portion of the first surface member 54a of the corner cover 54 and the surface member 26a of the rosette cover 26 mounted on standard 5b″. The mounting of the first and second threshold plates also assist in determining whether the rosette covers 26 are parallel to each other and to the work deck 2. Adjustments may be made at this stage of assembly to correct for any misalignment of the rosette covers 26. Misalignment of the rosette covers 26 may affect the ability of the sound reducing curtains 30 to properly create a seal, as better described below. To adjust the rosette covers 26, the Van Thiel™ couplers 32 may be loosened such that the rosette cover 26 may be rotated into the desired position. The Van Thiel™ couplers 32 may then be re-secured to lock the rosette covers 26 in their proper position relative to the each other and the work deck 2 above and below.

Vertical panel angles 50 may then be mounted to each of the first and second opposing flanges 26b of each rosette cover 26 mounted on the standards 5b. The vertical panel angle 50 supports the panel t-bars 60 which support the plurality of sound reducing curtains 30 that are mounted onto the panel t-bars 60 so as to create a seal to substantially contain air and noise pollution within the enclosed scaffolding assembly 1. The vertical panel angles 50 are generally “L”-shaped and extend the longitudinal length of the rosette cover 26. Each vertical panel angle 50 includes a first surface member 50a which is detachably mounted to one of the opposing flanges 26b of the rosette cover 26. In an embodiment of the invention, the first surface member 50a of the vertical panel angle 50 includes a plurality of apertures that correspond with the apertures on the opposing flanges 26b of the rosette cover 26 such that the first surface member 50a of the vertical panel angle 50 may be mounted to the opposing flanges 26b of the rosette cover 26 by way of conventional securing means such as bolts that journal through the corresponding apertures on the opposing flanges 26b of the rosette cover 26 and the first surface member 50a of the vertical panel angel 50.

The vertical panel angle 50 also includes a second surface member 50b which is perpendicular to the first surface member 50a. The second surface member 50b of the vertical panel angle 50 includes at least one aperture wherein securing means may be inserted through to secure a panel t-bar 60 between two immediately adjacent vertical panel angles 50. In the embodiment wherein the enclosed scaffolding assembly 1 encloses only a portion or segment of the boiler wall, the vertical panel angle 50 is only mounted on one of the opposing flanges 26b of the rosette cover 26 mounted on the end-most standard 5b″ as the scaffolding structure terminates on the opposite side. For similar reasons, in the alternative embodiment wherein the enclosed scaffolding assembly 1 encloses the entire wall, the vertical panel angle 50 is only mounted to one of the opposing flanges 26b of the rosette cover 26 that is mounted on the immediately adjacent standard 5b′.

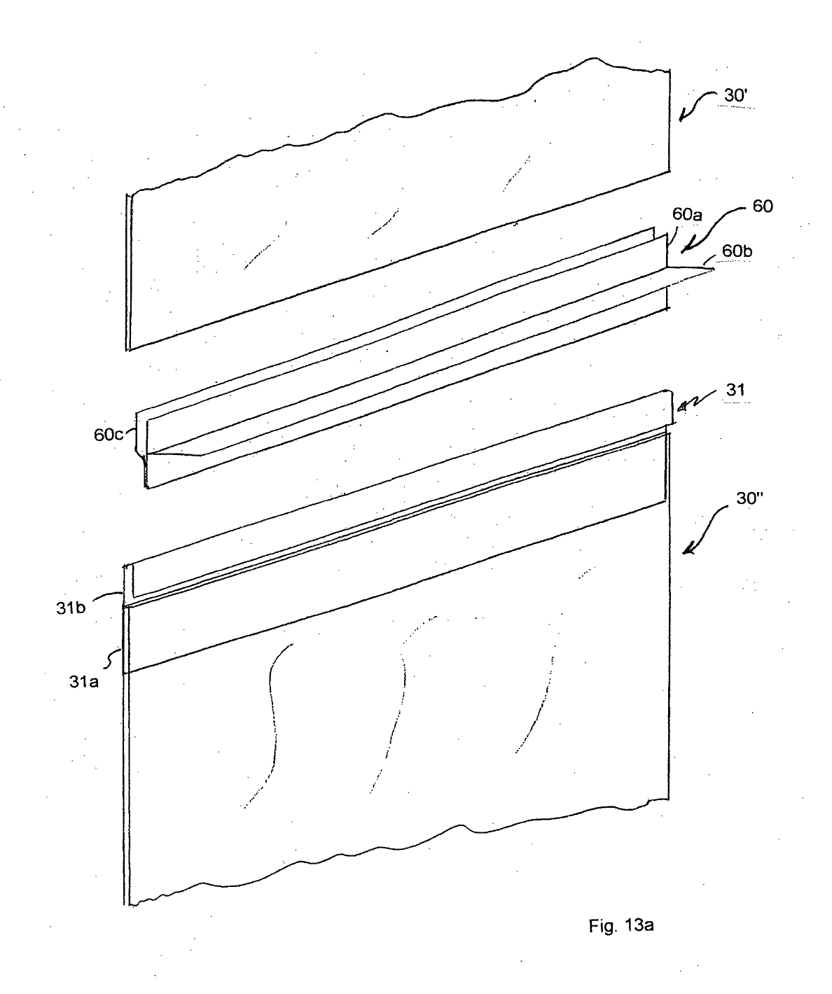

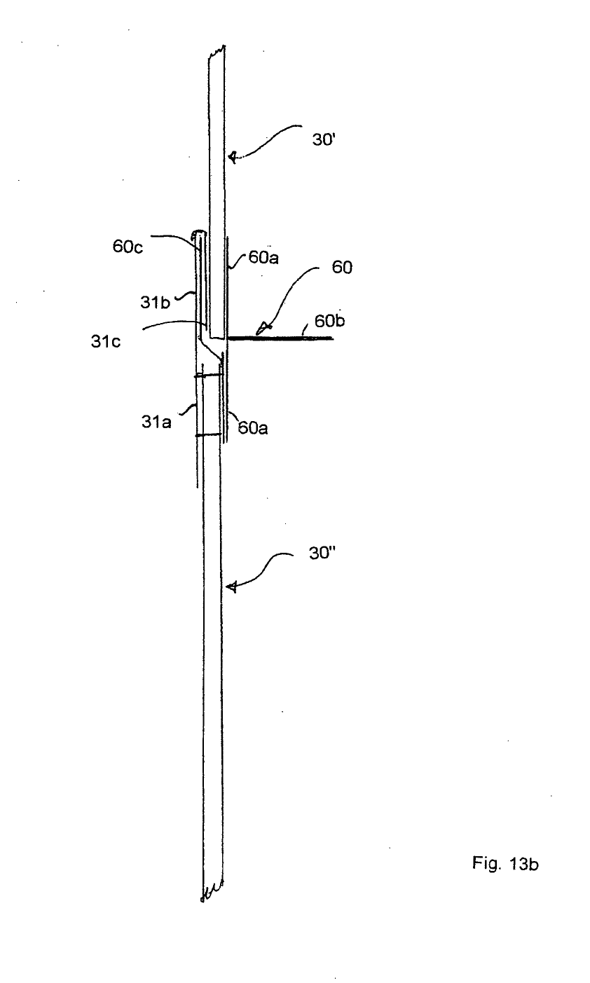

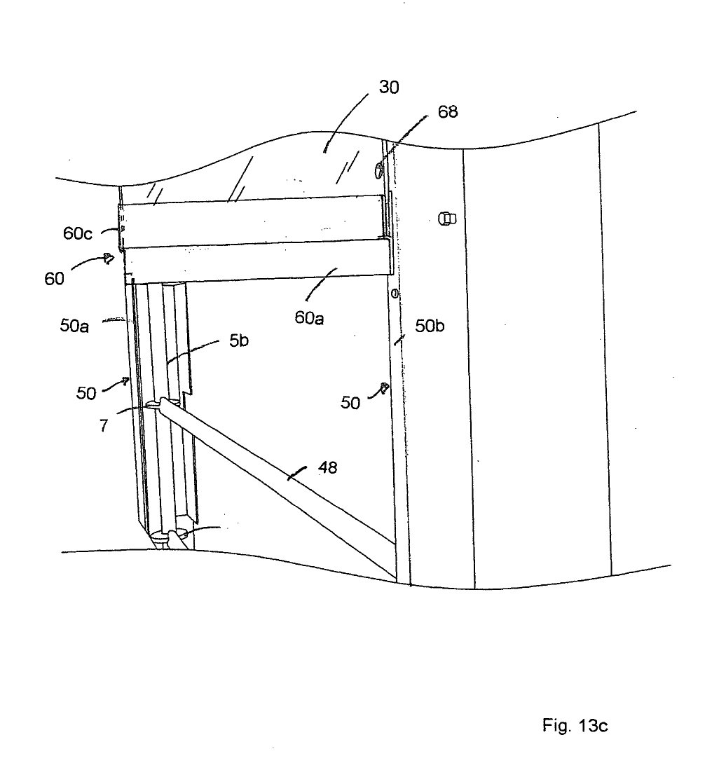

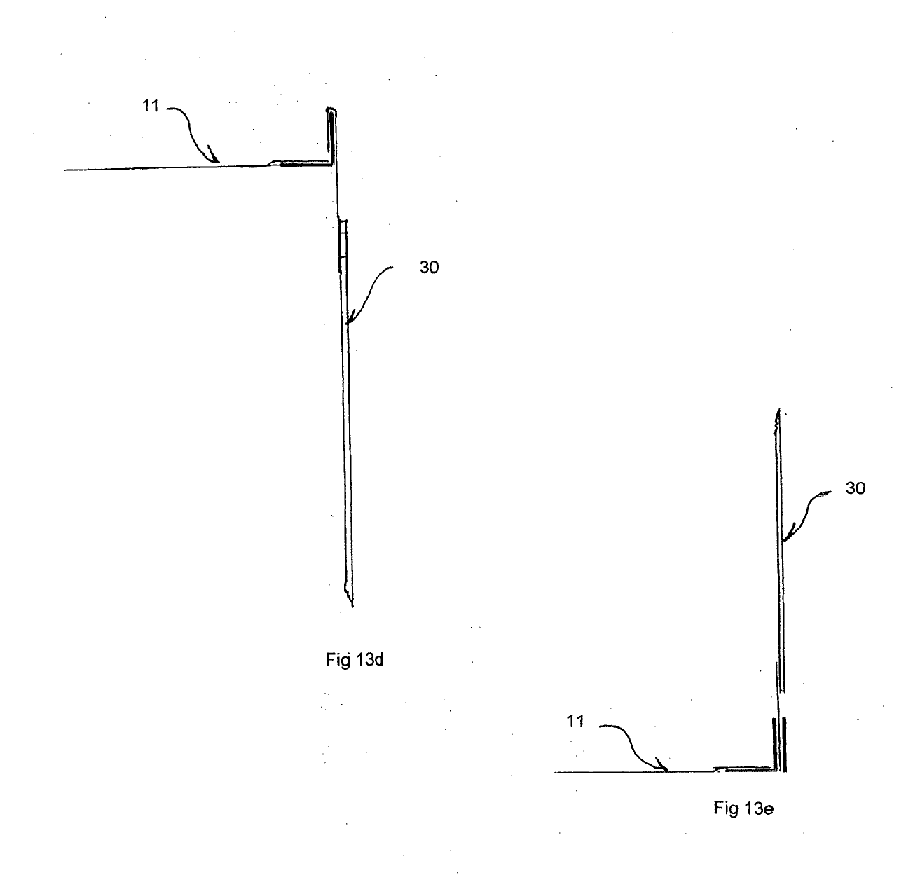

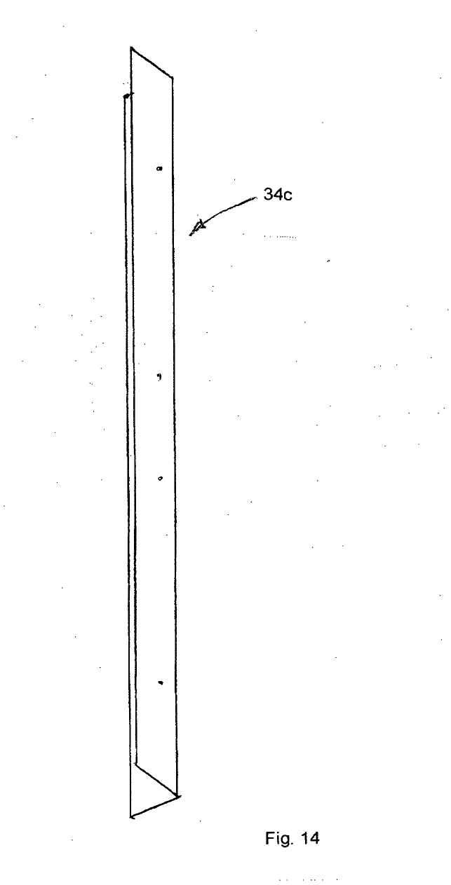

After mounting the vertical panel angles 50, the panel t-bar 60 may be mounted between immediately adjacent vertical panel angles 50. The panel t-bar 60 is generally “T”-shaped and includes a first flange member 60a and a second flange member 60b that is positioned centrally and perpendicular to the first flange member 60a. A flange 60c, parallel to flange member 60a forms a channel 61 on the side of flange member 60a opposite from flange 60b. As seen in FIG. 13a, a lower edge of an upper curtain 30′ mounts into channel 61 of panel t-bar 60. A lower curtain 30″ is mounted so as to depend from panel t-bar 60 by means of curtain hanger 31. Hanger 31 has a downwardly opening channel 31a into which is mounted an upper edge of curtain 30″. A hook-shaped rail 31b is mounted to, and extends upwardly from, channel 31a. Hook-shaped rail 31b hooks over the upper edge of flange 60c as better seen in FIG. 13b so as to wedge the distal edge 31c of hook-shaped rail 31b between flange 60c and the lower edge of curtain 30′.

The sound reducing curtains 30 are generally rectangular in shape and are detachably mounted to the scaffolding assembly so as to partially enclose the scaffolding assembly 1 around the boiler wall. In one embodiment, the sound reducing curtains 30 are made of clear vinyl which possesses high tensile and tear resistance as well as high noise attenuation so as to assist in containing noise within the scaffolding assembly. A sound reducing curtain 30 may be detachably mounted along a first edge to a first panel t-bar and along a second opposing edge to a second panel t-bar immediately above or below the first panel t-bar. A third and a fourth opposing edge of the sound reducing curtain 30 may be mounted to a first vertical panel angle and a second vertical panel angle immediately adjacent to the first vertical panel angle, respectively.

In the embodiment wherein the enclosed scaffolding assembly 1 encloses only a portion or segment of the boiler wall, closure panel 62 may be mounted perpendicular to the boiler wall or active wall to seal the gap between the wall and the extreme exterior standards 5a of the scaffolding assembly. A first longitudinal side of the closure panel is mounted to the corner cover 34 mounted on the end-most standard 5a and a sealing bar mounted to a second opposing longitudinal side of the closure panel engages the boiler wall to create a seal. The closure panel 62 is generally rectangular in shape and is configured to support a sound reducing panel 40. In an embodiment of the invention, the closure panel includes a generally rectangular frame 72 having a first side 72a and a second side 72b. Extending out from the edge of the first side 72a of the frame 72 and around the perimeter of the frame is a first flange 74. Similarly, extending out from the edge of the second side 72b of the frame 72 and around the perimeter of the frame 72 is a second flange 76. The first and the second flange 74, 76 of the frame 72 include a plurality of apertures 78 that correspond with the plurality of apertures around the sound reducing panel 40 wherein the sound reducing panel may be detachably mounted to either side of the frame 72. The apertures 78 along both longitudinal sides of the first and the second flange 74, 76 also correspond with the plurality of apertures 33 on the second surface member 34b of the corner cover 34 such that the closure panel 62 may be mounted to the second surface member 34b of the corner cover 34 by conventional securing means, such as bolts that journal through the corresponding apertures 33 on the second surface member 34b of the corner cover 34 and the apertures 78 on one of the longitudinal sides of the frame 72.

Sound reducing panels 40 may be made of a quilted noise barrier material, such as sound curtains provided by Unger Technologies Inc. which may reduce noise by approximately twenty decibels. In an embodiment of the invention, the generally rectangular sound reducing panel 40 is mounted to a generally rectangular frame that may be detachably mounted on the first or the second flange 74, 76 of the closure panel frame 72. The rectangular frame of the sound reducing panel 40 includes a plurality of apertures that correspond with the plurality of apertures 78 on the first and the second flange 74, 76 of the closure panel frame 72. The sound reducing panel 40 may then be detachably mounted on either side of the closure panel frame 72 by conventional securing means such as plugs which journal through the corresponding apertures. The closure panel 62 with the sound reducing panel 40 mounted thereon may then be mounted to the corner cover 34 as described above.

In the full enclosure embodiment, the closure panel 62 is mounted parallel to the boiler wall. As such, the closure panel 62 is mounted to the second surface member 34b of the corner cover 34 mounted on the end-most standard 5b″. The plurality of apertures 78 on the longitudinal sides of the closure panel frame 72 corresponds with the apertures 33 on the second surface member 34b of the corner cover 34. The closure panel 62 with the sound reducing panel 40 mounted thereon may be detachably mounted to the second surface member 34b of the corner cover 34 mounted on the end-most standard 5b″ by conventional securing means such as bolts which journal through the corresponding apertures.

In the embodiment wherein the enclosed scaffolding assembly 1 encloses only a portion or segment of the boiler wall, to completely enclose the scaffolding assembly, a door 20 is mounted between the end-most standard 5a and the end-most standard 5b″ at both opposite ends of the scaffolding assembly. A door stop angle (not shown) may be detachably mounted to the surface member 26a of the rosette cover 26 mounted on the standard 5b″. A door 20 is then hung such that the hinge side of the door is mounted to the same side of the door stop angle. Preferably, the door 20 includes a generally rectangular frame that supports a clear vinyl sound reducing sheet 80 similar to the sound reducing curtain 30. In the alternative fill enclosure embodiment, the door stop angle is detachably mounted to the first surface member 54a of the corner cover 54 mounted on standard 5b′ immediately adjacent to the standard 5b″ and the door 20 is hung on the corner cover 34 mounted on the standard 5b″.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A scaffolding assembly erectable substantially adjacent to a structure, the scaffolding assembly comprising:
a plurality of sound attenuating sheets, detachably mounted on a frame wherein said frame includes sheet supporting members, and wherein said sheet supporting members and said plurality of sound attenuating sheets when mounted on said sheet supporting members define an enclosed working area adjacent the structure, so as to affect a seal to substantially contain air and noise pollution within the enclosed scaffolding assembly when adjacent to the structure,
wherein said enclosed working area is open on an open side immediately adjacent to an adjacent wall of the structure and closed to the ambient external environment on an exterior side of said working area opposite said open side and a top, bottom and ends of said working area, said scaffolding assembly including a vertically spaced apart the working decks of said array parallel and horizontal array of elongate working decks, within said enclosed working area, each said working deck of said array having an interior edge most closely adjacent the adjacent wall of the structure and said open side, and an opposite exterior edge adjacent said sheets on said exterior side,
and wherein said scaffolding assembly further includes an inclined catchment ramp mounted along the length of and adjacent to said interior edge of at least one said working deck of said array of elongate working decks so as to sandwich each said ramp substantially snugly between said at least one working deck and the adjacent wall of the structure, wherein each said ramp is inclined upwardly from a corresponding said interior edge towards the adjacent wall of the structure so as to catch detritus including debris and particulate matter falling from the adjacent wall of the structure and so as to urge said detritus downwards towards said interior edge,
and wherein a disposal aperture is formed along said interior edge for disposal therethrough of said detritus as it is urged from said ramp.

2. The device of claim 1 wherein said sheets include sound dampening flexible curtains.

3. The device of claim 1 wherein said sheets include sound dampening panels.

4. The device of claim 1 wherein said aperture is a vacuum inlet adapted for mounting in vacuum communication with a vacuum source for drawing said debris and particulate matter into said aperture, whereby said debris and particulate matter is removed from said scaffold enclosure.

5. The device of claim 4 wherein an elongate funnel is formed in said work deck along said interior edge, and wherein said aperture is recessed beneath said work deck at a lower end of said funnel.

6. The device of claim 1 wherein said working deck has, in a horizontal plane, a length and a depth, wherein said length is parallel to the adjacent wall of the structure and said depth is orthogonal to said length, and wherein said ramp has a length parallel to said length of said working deck and a depth substantially parallel to said depth of said working deck, and wherein said depth of said ramp is substantially equal to said depth of said working deck.

7. The device of claim 6 wherein said length of said ramp is substantially equal to said length of said working deck.

8. The device of claim 1 wherein said ramp is mounted to at least a top-most and a bottom-most said working deck of said at least one working deck in said array of elongate working decks to thereby substantially seal a top and a bottom of said array against the adjacent wall of the structure.

9. The device of claim 8 wherein said sheets on said frame at said ends of said working area include both end sheets and at least one door mounted on said frame to respectively substantially seal said ends of said working area and to provide access into said working area.

10. The device of claim 8 wherein said scaffolding assembly is erectable for snug substantially sealed mating engagement against an interior corner of the inside of the structure and thus wherein said working area and working decks includes an L-shape when viewed in plan view, and wherein each said ramp for said at least a top-most and a bottom-most said working deck extends the length of said L-shape so as to extend from each opposite end of said L-shape and around said interior corner so as to substantially seal thereagainst.

11. The device of claim 10 wherein said sheets on said frame at said ends of said working area include both end sheets and at least one door mounted on said frame to respectively substantially seal said ends of said working area and to provide access into said working area.

12. The device of claim 1 further comprising an elongate, secondary sealing element mounted along an interior-most edge of each said ramp, wherein said interior-most edge is most closely adjacent the adjacent wall of the structure.

13. The device of claim 12 wherein said sealing element extends the entire length of each said ramp and is detachably and selectively adjustably mounted on each said ramp for adjustable snugging of said sealing element into substantially abutted engagement against the adjacent wall of the structure.
